(19) United States
(12) Patent Application Publication
(10) Pub. No.: US 2014/0078791 A1
(43) Pub. Date: Mar. 20, 2014

(54) SYSTEMS AND METHODS FOR CONTROLLING AN INVERTER

(71) Applicants: Vijay Dayaldas Gurudasani, Hyderabad (IN); Remesh Kumar Keeramthode, Secunderabad (IN); Rekha Kandiyil Raveendran, Hyderabad (IN); NVS Kumar Srighakollapu, Hyderabad (IN)

(72) Inventors: Vijay Dayaldas Gurudasani, Hyderabad (IN); Remesh Kumar Keeramthode, Secunderabad (IN); Rekha Kandiyil Raveendran, Hyderabad (IN); NVS Kumar Srighakollapu, Hyderabad (IN)

(21) Appl. No.: 13/618,776

(22) Filed: Sep. 14, 2012

(51) Int. Cl. H02M 5/458

(52) U.S. Cl. 363/37

(57) ABSTRACT

An inverter apparatus for a photovoltaic panel includes a primary microcontroller configured to send a conversion signal to a DC to AC conversion unit. The inverter further includes a first isolator and a secondary microcontroller communicatively coupled to the primary microcontroller through the first isolator. The secondary microcontroller is configured to provide more than one communication mode to the primary microcontroller for communicating with a remote system.

### BACKGROUND OF THE INVENTION

The embodiments described herein relate generally to monitoring and operating a micro inverter, and more specifically, to providing electrically isolated monitoring and control of a primary microcontroller of a micro inverter.

Light is an example of a renewable source of energy that is becoming increasingly attractive as an alternative source of energy. Solar energy in the form of sunlight may be converted to electrical energy by solar cells. A more general term for devices that convert light to electrical energy is “photovoltaic cells.” The electrical energy output of a photovoltaic (“PV”) cell is in the form of direct current (“DC”). In order for this DC output to be utilized by at least some conventional alternating current (“AC”) electronic devices, as well as the electric power grid, it must first be converted from DC to AC. Conventionally, this DC to AC conversion is performed with a power converter.

One type of solar power converter, a micro inverter, converts DC electricity from a single solar panel to AC. Conventionally, the electric power from several micro-inverters is combined and fed into an electrical distribution network, or “grid.” Micro inverters contrast with conventional string or central inverter devices, which are connected to multiple solar panels (e.g., solar panel arrays).

A conventional micro inverter primarily employs a DC to AC converter and a microcontroller that controls the DC to AC converter as well as extra operations, such as communication with outside systems and monitoring of PV cell energy output. Controlling critical DC to AC conversion as well as processing ancillary operations in a single microcontroller is a deficiency in that extra processing cycles are required of the microcontroller to accomplish many tasks. Furthermore, controlling DC to AC conversion as well as processing ancillary operations in a single microcontroller places the processing of ancillary operations in jeopardy in the event of a microcontroller failure caused by an attached DC to AC converter. Even further, controlling DC to AC conversion as well as processing ancillary operations in a single microcontroller limits upgradability of the microcontroller for additional features.

To overcome these deficiencies, micro inverters have been designed to employ a primary microcontroller for controlling DC to AC conversion, and a slave microcontroller for controlling other operations of the photovoltaic panel, such as communication with outside systems and monitoring of energy parameters. However, deficiencies still exist with these conventional systems. The slave microcontroller, for example, can be damaged by an electrical fault in the primary microcontroller. Furthermore, conventional slave microcontrollers are configured to permit only a single mode of communication with outside systems, limiting the modes by which the inverter can communicate with outside systems.

### BRIEF DESCRIPTION OF THE INVENTION

In one aspect, a micro inverter apparatus for a photovoltaic panel is provided, that includes a primary microcontroller configured to send a conversion signal to a DC to AC conversion unit. The micro inverter apparatus also includes a first isolator and a secondary microcontroller. The secondary microcontroller is communicatively coupled to the primary microcontroller via the first isolator. The secondary microcontroller is configured to provide more than one communication mode to the primary microcontroller for communicating with a remote system.

In another aspect, a micro inverter system is provided that includes a photovoltaic panel. A DC to AC conversion unit is configured to be in electrical communication with both the photovoltaic panel and the grid. The DC to AC conversion unit converts DC power from the photovoltaic panel to AC power for offloading onto the grid. A primary microcontroller is configured to send a conversion signal to the DC to AC conversion unit. A first isolator couples a secondary microcontroller to the primary microcontroller. The secondary microcontroller is configured to provide more than one communication mode to the primary microcontroller for communicating with a remote system.

In another aspect, a method of controlling a micro inverter for a photovoltaic panel having a primary microcontroller in communication and electrical isolation with a secondary microcontroller is provided. The method includes the steps of retrieving operating parameters for the primary microcontroller from an external electrically erasable programmable read only memory (“EEPROM”) and controlling grid synchronization of an output of the micro inverter by phase using the primary microcontroller. The method further includes the steps of monitoring the behavior of the primary microcontroller with the external EEPROM, recording the monitored behavior in the external EEPROM, and communicating data to and from the primary microcontroller through the secondary microcontroller.

### BRIEF DESCRIPTION OF THE DRAWINGS

FIGS. 1-5 show exemplary embodiments of the systems and methods for controlling a micro inverter described herein.

FIG. 1 is a schematic system block diagram of an exemplary system for controlling a micro inverter.

FIG. 2 is a schematic diagram of an exemplary power generation system utilizing a micro inverter.

FIG. 3 is a flow chart of an exemplary method for controlling a micro inverter.

FIG. 4 is a diagram illustrating the events which cause an EEPROM read, according to an exemplary method for controlling a micro inverter.

FIG. 5 is a flow chart of an exemplary method for controlling a micro inverter.

### DETAILED DESCRIPTION OF THE INVENTION

As described herein, a power generation system includes a power converter and at least one power generation unit, such as a solar array. The power converter is coupled to a power source such as the solar array and to an inverter. The inverter is coupled to an electrical distribution network for supplying electrical energy to the network. According to the exemplary embodiment, the power converter is a fly back converter. Alternatively, the power converter may be a forward converter, push-pull converter, or any other isolated converter that enables the power conversion system to function as described herein. Also, the power converter may be a parallel combination of multiple converters. A converter controller controls the operation of the power converter, and an inverter controller controls the operation of the inverter. The converter controller operates the fly back converter in a current control mode if a voltage of the solar array exceeds a predefined voltage threshold. The generated power will be fed to the grid through an inverter that is controlled by the inverter controller.

The methods and systems described herein facilitate operation of a micro inverter. More specifically, the methods and systems described herein facilitate the electrically isolated monitoring and control of a primary microcontroller of a micro inverter. Furthermore, the methods and systems described herein reduce the CPU burden on a primary microcontroller while providing multiple communication modes to the user. Even furthermore, the methods and systems described herein facilitate field upgradability of firmware of the microcontroller without affecting key functionality of the primary microcontroller. In the case of a primary microcontroller failure, an external EEPROM unit that has acted as an event and data logger can be accessed to perform a failure analysis and minimize downtime by enabling replacement of only the affected components.

A technical effect of the method described herein includes at least one of: (a) retrieving operating parameters for the primary microcontroller from an external EEPROM; (b) controlling grid synchronization of an output of the micro inverter by phase using the primary microcontroller; (c) monitoring the behavior of the primary microcontroller with the external EEPROM; (d) recording the monitored behavior in the external EEPROM; and (e) communicating data to and from the primary microcontroller through the secondary microcontroller.

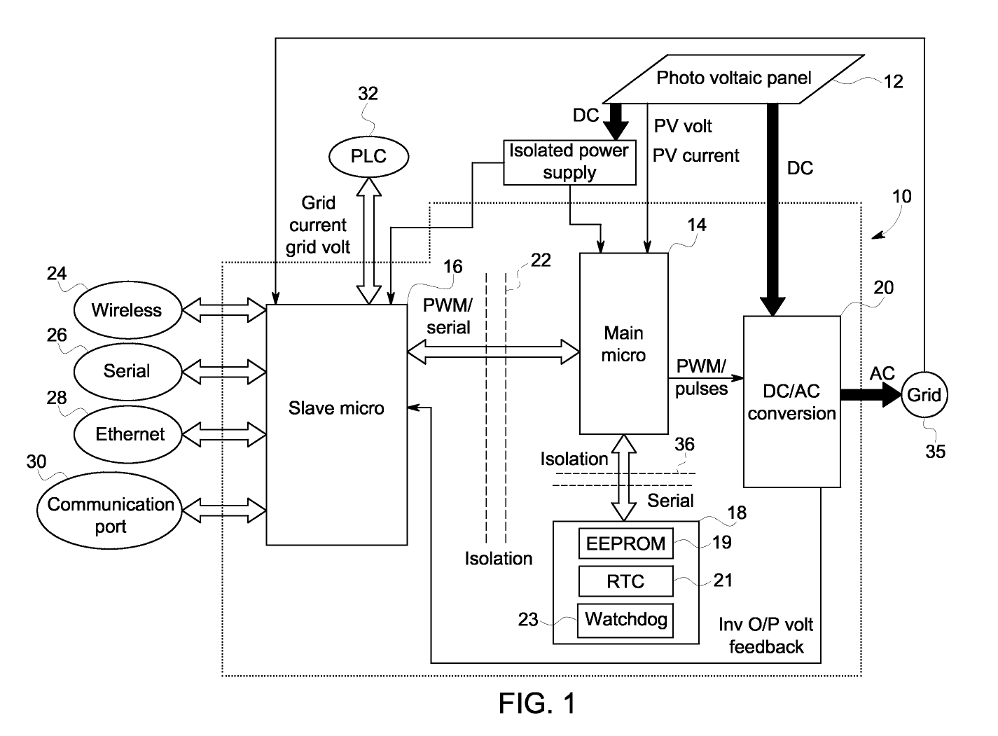

FIG. 1 is a schematic system block diagram of an exemplary system for controlling a micro inverter 10 included within a system for generating electricity from a solar panel 12. In the exemplary embodiment, solar panel 12 includes one or more of a photovoltaic panel, a solar thermal collector, or any other device that converts solar energy to electrical energy. In the exemplary embodiment, each solar panel 12 is a photovoltaic panel that generates a substantially direct current (DC) power as a result of solar energy striking solar panels 12.

In the exemplary embodiment, a primary microcontroller 14, a secondary microcontroller 16 and an external monitoring system 18 are all microcontrollers that include a processing device and a memory. The term “microcontroller,” as used herein, may refer to central processing units, microprocessors, microcontrollers, reduced instruction set circuits (RISC), application specific integrated circuits (ASIC), Digital Signal Processors (DSP), Field Programmable Logic Arrays (FPGA), logic circuits, and any other circuit or processor capable of executing the functions described herein. The above examples are exemplary only, and thus are not intended to limit in any way the definition and/or meaning of the term “microcontroller.”

Memory 19 stores program code and instructions, executable by processing device, to control and/or monitor various functions of the micro inverter 10. Memory may include, but is not limited to only include, non-volatile RAM (NVRAM), magnetic RAM (MRAM), ferroelectric RAM (FeRAM), read only memory (ROM), flash memory and/or Electrically Erasable Programmable Read Only

Memory (EEPROM). Any other suitable magnetic, optical and/or semiconductor memory, by itself or in combination with other forms of memory, may be included in memory. Memory may also be, or include, a detachable or removable memory, including, but not limited to, a suitable cartridge, disk, CD ROM, DVD or USB memory.

According to an exemplary embodiment, a micro inverter 10 apparatus for solar panel 12 includes primary microcontroller 14 configured to send a pulse width modulation (PWM) signal to a DC to AC conversion unit 20. In place of the PWM signal, and conversion signal suitable for enabling DC to AC conversion can be employed. The PWM signal is used to control the formation of an AC waveform from a DC current. Micro inverter 10 apparatus also includes a first isolator 22 and secondary microcontroller 16 communicatively coupled to primary microcontroller 14 via first isolator 22. Secondary microcontroller 16 is configured to provide more than one communication mode to primary microcontroller 14 for communicating with a remote system (not shown). For example, secondary microcontroller 16 provides data through wireless 24, serial 26, Ethernet 28, communication port 30, or power line carrier 32 communication modes. Secondary microcontroller 16 also monitors instantaneous samples of grid voltage, grid current and inverter output voltage of micro inverter 10 and communicates the same feed parameters to primary microcontroller 14 for achieving grid synchronization and micro inverter 10 output current control using isolation through first isolator 22.

Primary microcontroller 14 is configured to perform control operations including maximum power point tracking, grid synchronization, anti-islanding, output current control, diagnostic monitoring and safety monitoring. Maximum power point tracking is a control method used to maximize a power output of solar panels. Grid synchronization is a function which ensures that the output of DC to AC conversion unit 20 matches an electric grid 35. Anti-islanding functionality causes the independent sources to be disconnected from electric grid 35, when the utility power generator is disconnected from grid 35. Output current control functionality ensures desired output current magnitude and phase offloaded to grid based on the maximum peak input power available by the photovoltaic panel.

In the exemplary embodiment, first isolator 22 includes at least one of an optical isolator, an analog isolator, a digital isolator, a solid state isolator device and a high voltage protection circuit. An optical isolator is a device which employs light to convey signals from one endpoint to another, without providing direct electrical communication between endpoints. A digital isolator is a device that passes data and signals between endpoints by providing magnetic or capacitive coupling through an isolator channel. A solid state isolator device is a semiconductor device that enables system to function as described herein. An analog isolator is a device which employs a magnetic field to convey signals from one endpoint to another, without providing direct electrical communication between endpoints. A high voltage protection circuit is any circuit which enables the passage of low voltage signals between two endpoints but suppresses high voltage signals from passing between the endpoints.

According to one embodiment, the system also includes a second isolator 36 and external monitoring system 18 coupled to primary microcontroller 14 by second isolator 36. Second isolator 36 is, for example, at least one of an optical isolator, an analog isolator, a digital isolator, a solid state isolator device and a high voltage protection circuit.

External monitoring system 18 is configured to store operating information from primary microcontroller 14 in memory 19. According to an embodiment, memory 19 is an EEPROM. Utilizing real time clock 21 connected to memory 19, external monitoring system 18 can timestamp data retrieved from microcontroller 14 for use by technicians who may later evaluate the data.

According to an embodiment, external monitoring system 18 includes a watchdog circuit 23 that monitors the state of primary microcontroller 14 and effectuates the restart of primary microcontroller 14 in the event that primary microcontroller 14 fails. Watchdog circuit 23 ensures that a faulting primary microcontroller 14 is given opportunities to restart without requiring outside intervention.

Memory 19 of external monitoring system 18 can be programmed with configuration information for primary microcontroller 14. For example, programmed configuration information can include settings such as which communications modes to enable in secondary microcontroller 16. The programmed confirmation information can also include identifying unit information and node identification information for communications, so that a remote system can accurately identify one inverter from another.

During power on, primary microcontroller 14 retrieves operating information from external monitoring system 18 and provides a communication channel select command to secondary microcontroller 16 wherein the required communication channel is selected by secondary microcontroller 16 and the selected communication channel is provided to the primary microcontroller 14.

According to an embodiment, memory 19 of external monitoring system 18 is configured to store at least one of various inverter configurations, such as a maximum and minimum operating unit temperature. External monitoring system 18 conducts a health check of solar panel 12 and determines the status of any grid 35 connection. Along with the status of grid connection, external monitoring system 18 measures a grid current and voltage and records a fault history of solar panel 12 including over-current shutdown faults, sun levels and reasons for the fault. External monitoring system 18 also records a total time for which the unit has generated power, a unit efficiency including cumulative efficiency and maximum efficiency and the time of the inverter's last low power mode. Further, monitoring system 18 records a time of the inverter's last day mode and an amount of total energy generation.

Micro inverter 10 system 100 includes solar panel 12 and DC to AC conversion unit 20 in electrical communication with solar panel 12 and grid 35. DC to AC conversion unit 20 is configured to convert DC power from solar panel 12 to AC power for offloading onto grid 35. Primary microcontroller 14 is configured to send a pulse width modulation signal to DC to AC conversion unit 20. First isolator 22 communicatively couples secondary microcontroller 16 to primary microcontroller 14. Secondary microcontroller 16 is configured to provide more than one communication mode to primary microcontroller 14 for communicating with a remote system. The communication mode can include at least one of wireless communications mode 24, serial communications mode 26, Ethernet communications mode 28, and power line carrier communications mode 32. Secondary microcontroller 16 also monitors the instantaneous samples of grid voltage, grid current and inverter output voltage of micro inverter 10 and communicates the same feedback parameters to primary microcontroller 14 for achieving grid synchronization and micro inverter output current control using isolation through first isolator 22.

According to the exemplary embodiment, primary microcontroller 14 is configured to perform control operations including maximum power point tracking, grid synchronization, anti-islanding, output current control, diagnostic monitoring and safety monitoring. First isolator 22 includes at least one of an optical isolator, an analog isolator, a digital isolator, a solid state isolator device and a high voltage protection circuit. System 100 further includes second isolator 36 and external monitoring system 18 coupled to primary microcontroller 14 via second isolator 36. Second isolator 36 includes at least one of an optical isolator, an analog isolator, a digital isolator, a solid state isolator device and a high voltage protection circuit. External monitoring system 18, according to some embodiments, comprises a watchdog circuit for resetting primary microcontroller 14 in the event of primary microcontroller 14 failure or time-out event.

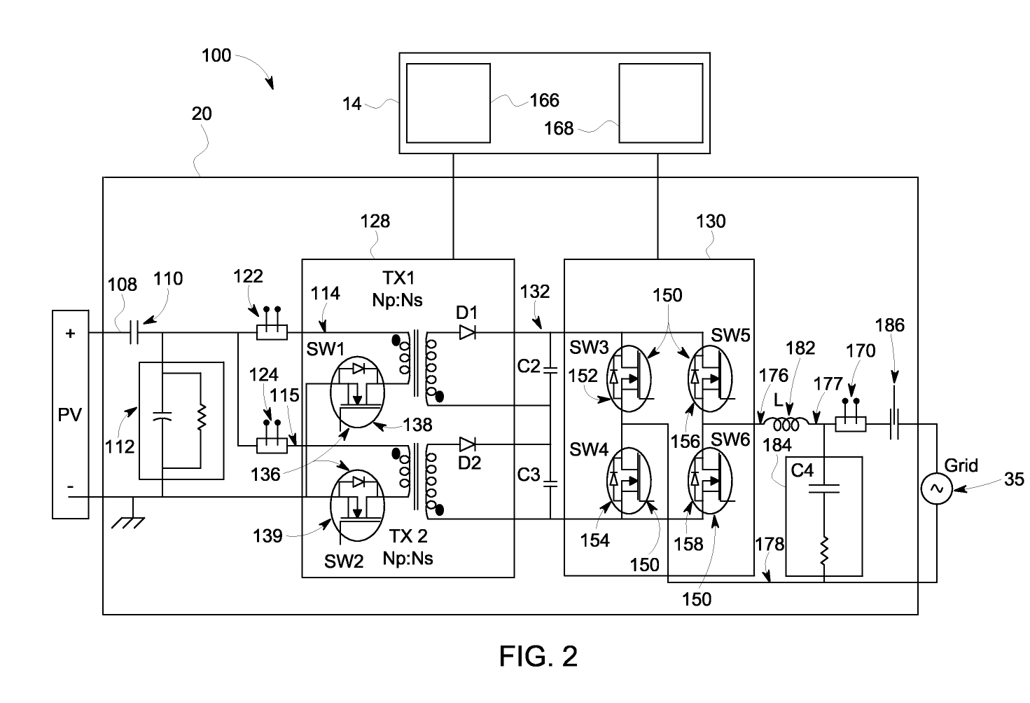

FIG. 2 is a schematic diagram of an exemplary power generation system 100 that includes a power generation unit, such as solar panel 12, illustrating the exemplary operation of DC to AC conversion unit 20. Alternatively, power generation system 100 includes any suitable number and type of power generation units, such as a plurality of wind turbines, fuel cells, geothermal generators, hydropower generators, and/or other devices that generate power from renewable and/or non-renewable energy sources.

In the exemplary embodiment, solar panel 12 is coupled to DC to AC conversion unit 20, or power converter system, that converts the DC power to alternating current (AC) power. The AC power is transmitted to electrical distribution network 35, or “grid.” Power converter 20, in the exemplary embodiment, adjusts an amplitude of the voltage and/or current of the converted AC power to an amplitude suitable for electrical distribution network 35, and provides AC power at a frequency and a phase that are substantially equal to the frequency and phase of electrical distribution network 35. Moreover, in the exemplary embodiment, power converter 20 provides single phase AC power to electrical distribution network 35. Alternatively, power converter 20 provides three phase AC power or any number of phases of AC power to electrical distribution network 35.

DC power generated by solar panel 12, in the exemplary embodiment, is transmitted through a converter conductor 108 coupled to power converter 20. In the exemplary embodiment, a protection device 110 electrically disconnects solar panel 12 from power converter 20, for example, if an error or a fault occurs within power generation system 100. As used herein, the terms “disconnect” and “decouple” are used interchangeably, and the terms “connect” and “couple” are used interchangeably. Current protection device 110 is a circuit breaker, a fuse, a contactor, and/or any other device that enables solar panel 12 to be controllably disconnected from power converter 20. A DC filter 112 is coupled to converter conductor 108 for use in filtering an input voltage and/or current received from solar panel 12.

Converter conductor 108, in the exemplary embodiment, is coupled to a first input conductor 114, and a second input conductor 115 such that the input current is split between a first input conductor 114 and a second input conductor 115. Alternatively, the input current may be conducted through a single conductor, such as converter conductor 108, or to any other number of conductors that enables power generation system 100 to function as described herein. In the exemplary embodiment, a first input current sensor 122 is coupled to first input conductor 114, and a second input current sensor 124 is coupled to second input conductor 115. First and second input current sensors 122, 124 measure current flowing through first and second input conductors 114, 115.

In the exemplary embodiment, power converter 20 includes a DC to rectified AC converter 128 (i.e., flyback converter) and an inverter 130 coupled together by capacitors 132. Flyback converter 128, in the exemplary embodiment, is coupled to and receives DC power from solar panel 12 through first and second input conductors 114, 115. Moreover, flyback converter 128 adjusts the voltage and/or current amplitude of the DC power received. In the exemplary embodiment, inverter 130 is an unfolding H-bridge inverter that converts rectified AC power received from flyback converter 128 into AC power suitable for transmission to electrical distribution network 35.

Flyback converter 128, in the exemplary embodiment, includes one converter switch 138 for each phase of electrical power that power converter 20 produces. Converter switch 138 is a Metal Oxide Semiconductor Field Effect Transistor (MOSFET). Alternatively, converter switch 138 is any other suitable transistor or any other suitable switching device.

Inverter 130 includes four inverter switching devices coupled together: a first inverter switching device 152; a second inverter switching device 154; a third inverter switching device 156; and a fourth inverter switching device 158. In the exemplary embodiment, each inverter switching device is substantially similar to first converter switching device 138 and second converter switching device 139. Alternatively, each inverter switching device 152, 154, 156, and 158 may include a gallium nitride field effect transistor (GaN FET), an insulated gate bipolar transistor (IGBT), or any other device that enables system 100 to function as described herein. Gate terminals of each switching device are coupled to inverter controller 168 for controlling the switching operation of first, second, third, and fourth inverter switching devices 152, 154, 156, and 158. In addition, first inverter switching device 152 is switched complimentary with respect to second inverter switching device 154, and third inverter switching device 156 is switched complimentary with respect to fourth inverter switching device 158. As such, for power converter 20, inverter 130 includes a first inverter switch 152 coupled in series with a second inverter switch 154, and a third inverter switch 154 coupled in series with a fourth inverter switch 158. First and second inverter switches 152, 154 are coupled in parallel with third and fourth inverter switches 156, 158. Alternatively, inverter 130 includes any suitable number of inverter switches 150 arranged in any suitable configuration.

Power converter 20 is attached to control system (e.g., main microcontroller 14) that includes a converter controller 166 and an inverter controller 168. Converter controller 166 is coupled to, and controls an operation of flyback converter 128. More specifically, in the exemplary embodiment, converter controller 166 operates flyback converter 128 to maximize power received from solar panel 12. Inverter controller 168 is coupled to, and controls the operation of inverter 130. More specifically, in the exemplary embodiment, inverter controller 168 operates inverter 130 to regulate the voltage across DC capacitor(s) 132 and/or to adjust the voltage phase, frequency, or any other characteristic of power output from inverter 130 to substantially match the characteristics of electrical distribution network 35.

In the exemplary embodiment, control system, converter controller 166, and/or inverter controller 168 include or are implemented by at least one processor (e.g., main microcontroller 14). As used herein, the processor includes any suitable programmable circuit such as, without limitation, one or more systems and microcontrollers, microprocessors, reduced instruction set circuits (RISC), application specific integrated circuits (ASIC), programmable logic circuits (PLC), Digital Signal Processors (DSP), field programmable gate arrays (FPGA), or any other circuit capable of executing the functions described herein. The above examples are exemplary only, and thus are not intended to limit in any way the definition and/or meaning of the term “processor.”

Converter controller 166, in the exemplary embodiment, receives current measurements from first input current sensor 122 or second input current sensor 124. Moreover, converter controller 166 receives measurements of a voltage of first input conductor 114 or second input conductor 115 from a plurality of input voltage sensors (not shown). Inverter controller 168, in the exemplary embodiment, receives current measurements from a first output current sensor 170. Moreover, inverter controller 168 receives measurements of a voltage output from inverter 130 from a plurality of output voltage sensors (not shown). In the exemplary embodiment, converter controller 166 and/or inverter controller 168 receive voltage measurements of the voltage of DC capacitors 132 from a DC capacitor voltage sensor (not shown).

In the exemplary embodiment, inverter 130 is coupled to grid 35 by a first output conductor 176 and a second output conductor 178. A first output current sensor 170 is coupled to a grid line conductor 178 for measuring the current flowing through grid line conductor 178.

At least one inductor 182 is coupled to first output conductor 176. Inductors 182 facilitate filtering the output voltage and/or current received from inverter 130. Moreover, in the exemplary embodiment, an AC filter 184 is coupled to inductor output node (i.e., conductor 177).

In the exemplary embodiment, at least one contactor or disconnect switch 186 is coupled to first output conductor 176. Disconnect switches 186 electrically disconnect inverter 130 from grid 35, for example, if an error or a fault occurs within power generation system 100. Moreover, in the exemplary embodiment, protection device 110, contactors or disconnect switches 186 are controlled by control system 14. Alternatively, in protection device 110, disconnect switches 186 are controlled by any other system that enables power converter 20 to function as described herein.

During operation, solar panel 12 generates DC power and transmits the DC power to flyback converter 128. Converter controller 166 controls a switching of converter switches 136 to adjust an output of flyback converter 128. More specifically, in the exemplary embodiment, converter controller 166 controls the switching of converter switches 136 to adjust the voltage and/or current received from solar panel 12 such that the power received from solar panel 12 is increased and/or maximized.

Inverter controller 168 controls a switching of inverter switches 150 to adjust an output of inverter 130. For example, inverter controller 168 uses a suitable control algorithm, such as power frequency square pulses and/or any other control algorithm, to transform the rectified AC power received from flyback converter 128 into single phase AC power signals. Alternatively, inverter controller 168 causes inverter 130 to transform the rectified AC power into a three phase AC power signal or any other signal that enables power converter 20 to function as described herein.

In the exemplary embodiment, the AC power is filtered by AC filter 184, and the filtered single phase AC power is transmitted to electrical distribution network 35.

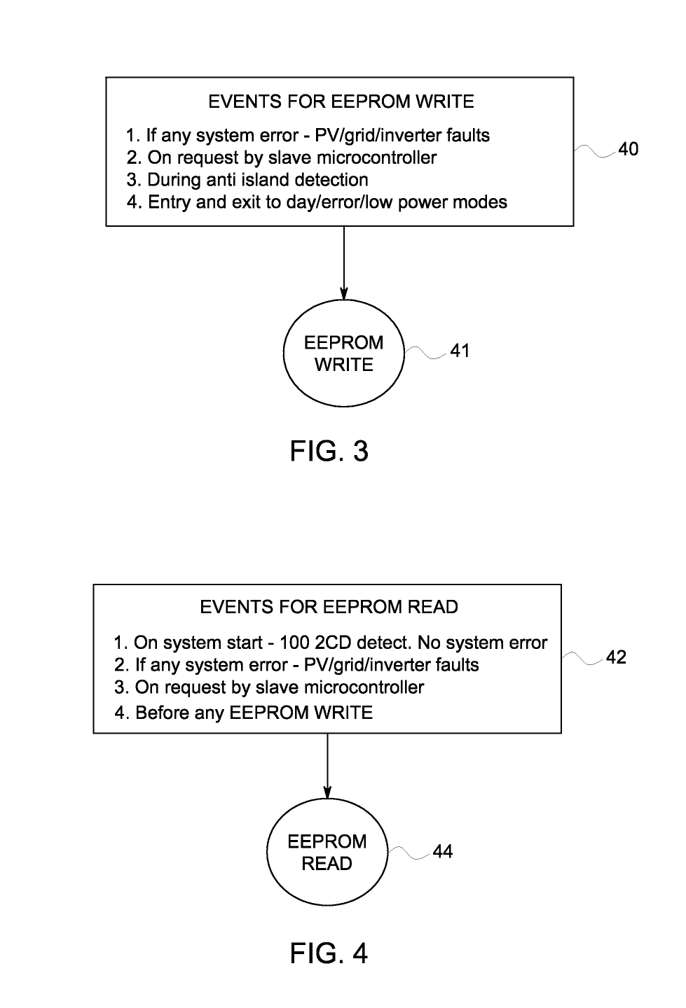

FIG. 3 is a process flow diagram illustrating operation of the external monitoring system 18. The external monitoring system 18 will record diagnostics (e.g., in an EEPROM write 41) every ten minutes unless there is a special event trigger 40. Special event triggers 40 include any system errors, including errors with the photovoltaic panel 12, the grid 35 or faults with the inverter. A write request from the slave microcontroller is also considered an event trigger, and will trigger a diagnostic write in the monitoring system 18 sooner than the predetermined ten minute interval.

FIG. 4 is a process flow diagram illustrating operation of external monitoring system 18. In the exemplary embodiment, external monitoring system 18 performs a read operation 44 to retrieve a particular type of data stored in monitoring system 18, returning that particular type of data to a data handling device outside external monitoring system 18, such as, for example, primary microcontroller 14. External monitoring system 18 performs a read operation 44 for certain events 42, including on system start, at which point a 100 zero current detection (ZCD) function is processed and no system errors are discovered. In the event of any system error, the most recent status of photovoltaic panels 12, grid 35, and the most recent inverter faults are recovered from external monitoring system 18. A request from slave microcontroller 16 can trigger an EEPROM read 44. Finally, an external EEPROM read event 42 is performed before each EEPROM write function.

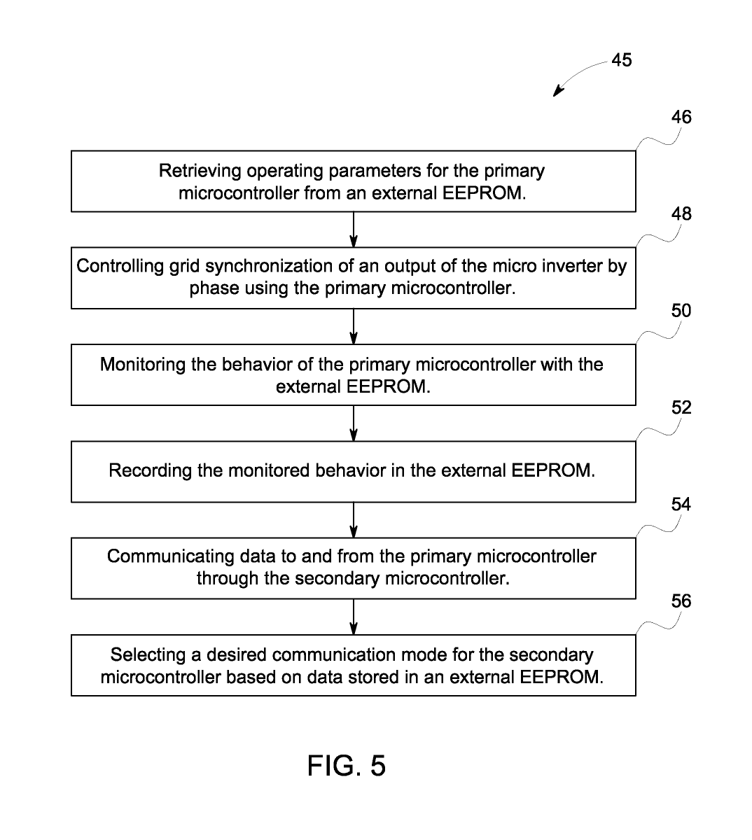

FIG. 5 depicts a method 45 of controlling micro inverter 10 for solar panel 12 having primary microcontroller 14 in communication and electrical isolation with secondary microcontroller 16. Method 45 includes the step of retrieving 46 operating parameters for primary microcontroller 14 from external monitoring system 18. Grid phase synchronization of an output of micro inverter 10 is controlled 48 by phase using primary microcontroller 14. The behavior of primary microcontroller 14 is monitored 50 with external monitoring system 18. External monitoring system 18 records 52 the monitored behavior and communicates 54 the recorded data to and from primary microcontroller 14 through secondary microcontroller 16. A desired communication mode for secondary microcontroller 16 is selected 56 based on data stored in external monitoring system 18.

Exemplary embodiments of systems and methods for controlling an inverter are described above in detail. The systems and methods are not limited to the specific embodiments described herein, but rather, components of systems and/or steps of the methods may be utilized independently and separately from other components and/or steps described herein. For example, the methods may also be used in combination with other inverter control systems and methods, and are not limited to practice with only the inverter controlling systems and methods as described herein. Rather, the exemplary embodiment can be implemented and utilized in connection with many other inverter control applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An inverter apparatus for a photovoltaic panel, said apparatus comprising:
a primary microcontroller configured to send a conversion signal to a DC to AC conversion unit;
a first isolator; and
a secondary microcontroller communicatively coupled to the primary microcontroller through the first isolator, the secondary microcontroller configured to make available to the primary microcontroller more than one communication mode for communicating with a remote system.

2. The inverter of claim 1, wherein the more than one communication mode comprises at least one of a wireless communications mode, a serial communications mode, an Ethernet communications mode, and a power line carrier communications mode.

3. The inverter of claim 1, wherein the primary microcontroller is configured to perform a control operation comprising at least one of maximum power point tracking, grid synchronization, anti-islanding, output current control, diagnostic monitoring and safety monitoring.

4. The inverter of claim 1, wherein the first isolator comprises at least one of an optical isolator, an analog isolator and a high voltage protection circuit.

5. The inverter of claim 1, further comprising:
a second isolator; and
an external memory coupled to the primary microcontroller through the second isolator.

6. The inverter of claim 5, wherein the second isolator comprises at least one of an optical isolator, an analog isolator, a digital isolator, a solid state isolator device and a high voltage protection circuit.

7. The inverter of claim 5, wherein the external memory is configured to store operating information from the primary microcontroller.

8. The inverter of claim 5, wherein the external memory is configured to include a real time clock for timestamping data retrieved from the primary microcontroller.

9. The inverter of claim 5, wherein the external memory comprises a watchdog circuit configured to reset the primary microcontroller in the event of a primary microcontroller failure.

10. The inverter of claim 5, wherein the external memory is programmed with configuration information for the primary microcontroller.

11. The inverter of claim 5, wherein the external memory is configured to store at least one of a maximum and minimum operating unit temperature, a health check of the photovoltaic panel, a status of grid connection, a grid current and voltage, a fault history of the photovoltaic panel including over-current shutdowns, radiation levels and reasons for the fault, a total time for which the unit has generated power, and a unit efficiency.

12. An inverter system comprising:
a photovoltaic panel;
a DC to AC conversion unit configured to be in electrical communication with the photovoltaic panel and an electric grid, the DC to AC conversion unit configured to convert DC power from the photovoltaic panel to AC power for offloading onto the grid;
a primary microcontroller configured to send a conversion signal to the DC to AC conversion unit for controlling the conversion;
a first isolator; and
a secondary microcontroller communicatively coupled to the primary microcontroller through the first isolator, the secondary microcontroller configured to make available to the primary microcontroller more than one communication mode for communicating with a remote system.

13. The inverter system of claim 12, wherein the more than one communication mode comprises at least one of a wireless communications mode, a serial communications mode, an Ethernet communications mode, and power line carrier communications mode.

14. The inverter system of claim 12, wherein the primary microcontroller is configured to perform control operations comprising at least one of maximum power point tracking, grid synchronization, anti-islanding, output current control, diagnostic monitoring and safety monitoring.

15. The inverter system of claim 12, wherein the first isolator comprises at least one of an optical isolator, an analog isolator, a digital isolator, a solid state isolator device and a high voltage protection circuit.

16. The inverter system of claim 12, further comprising:
a second isolator; and
an external memory coupled to the primary microcontroller through the second isolator.

17. The inverter system of claim 16, wherein the second isolator comprises at least one of an optical isolator, an analog isolator and a high voltage protection circuit.

18. The inverter system of claim 16, wherein the external memory is configured to include a watchdog circuit for resetting the primary microcontroller in the event of a primary microcontroller failure.

19. A method of controlling an inverter for a photovoltaic panel having a primary microcontroller in communication with a secondary microcontroller; said primary microcontroller in electrical isolation with said secondary microcontroller, the method comprising:
retrieving operating parameters for the primary microcontroller from an external memory;
controlling grid synchronization of an output of the micro inverter using the primary microcontroller;
monitoring the actions of the primary microcontroller with the external memory;
recording the monitored actions in the external memory; and
communicating data to and from the primary microcontroller through the secondary microcontroller.

20. The method of claim 19, further comprising:
controlling output current of inverter using the primary microcontroller; and
selecting a desired communication mode for the secondary microcontroller based on data stored in an external memory.
